(19) United States
(12) Patent Application Publication
(10) Pub. No.: US 2026/0245055 A1
(43) Pub. Date: Aug. 20, 2026

(54) Method and System of Creating Transaction Traceability

(71) Applicant: MASTERCARD INTERNATIONAL INCORPORATED, Purchase, NY (US)

(72) Inventors: Peter Opiyo ODEGI, Nairobi (KE); Imelda Mueni NGUNZU, Nairobi (KE); Sherline KHALAYI, Nairobi (KE); Bernard OKECH, Nairobi (KE); Kevin KARANJA, Machakoa (KE)

(73) Assignee: MASTERCARD INTERNATIONAL INCORPORATED, Purchase, NY (US)

(21) Appl. No.: 19/536,872

(22) Filed: Feb. 11, 2026

Related U.S. Application Data
(60) Provisional application No. 63/760,361, filed on Feb. 19, 2025.

(51) Int. Cl. G06Q 20/04; G06Q 20/10; G06Q 20/20

(52) U.S. Cl. CPC G06Q 20/04; G06Q 20/10; G06Q 20/20; G06Q 2220/00

(57) ABSTRACT

A method for creating traceability within a network system includes receiving, from a first computing system, a first account request message; receiving, from a second computing system, a second account request message; creating first and second tagged blockchain accounts on a blockchain that runs in parallel with a payment gateway service maintained by the processing server; receiving, from the first computing system, a disbursement request that identifies (i) an account identifier associated with the first tagged blockchain account, (ii) an account identifier associated with the second tagged blockchain account, and (iii) an amount of tagged funds; transferring the amount of tagged funds from the first tagged blockchain account to the second tagged blockchain account; and creating a genesis block on the blockchain that includes a unique identifier tag assigned to the received disbursement request and disbursement details associated with the disbursement of the tagged funds.

### FIELD

The present disclosure relates to systems and methods that enable blockchain based traceability of immutable transactions and, more specifically, to a transfer mechanism in which traceability is created by tagging transactions at a source to ensure noninterference.

### BACKGROUND

Blockchain was initially created as a storage mechanism for use in conducting payment transactions with a cryptographic currency. Using a blockchain provides a number of benefits, such as decentralization, distributed computing, transparency regarding transactions, and yet also providing anonymity as to the individuals or entities involved in a transaction. One of the more popular aspects of a blockchain is that it is an immutable record: every transaction ever that is part of the chain is stored therein and cannot be changed due to the computational requirements and bandwidth limitations, particularly as a chain gets longer and a blockchain network adds more nodes.

Currently, when funds are distributed, via traditional payment networks and payment rails, from one party to another, there is no way to trace the funds in order to ensure that they are received by the intended recipient. For example, an organization such as World Bank may wish to disburse funds to an intermediary entity, for example, the Red Cross for further distribution to beneficiaries (individuals in need of the funds), e.g., refugees and others who may have low identification but many other categories of people. Payment transactions for such distribution/disbursement of funds are typically processed using a payment processor where data regarding the transactions themselves are included in the transaction messages, comprised of specially formatted data messages that are transmitted along payment rails, which is specialized infrastructure used by the payment processor and inaccessible by other systems and entities. However, there is no current mechanism to effectively trace those funds to ensure that (1) refugees are, in fact, receiving those funds, and (2) that the funds are being spent in a manner as intended.

Thus, there is a need for a technological solution to integrate traditional payment networks and payment rails with blockchain technology in order to create traceability by tagging financial transactions on a payment gateway at a source of the funds to ensure noninterference and to ensure transfer of funds to a recipient without any chance of corruption.

### SUMMARY

The present disclosure provides a description of systems and methods for creating traceability of immutable transactions within a network system utilizing a blockchain operating in parallel with a payment gateway service. When a first computing system (e.g., World Bank) would like to distribute funds to a second computing system (e.g., Red Cross), both computing systems first create a specialized account that is configured to handle tagged funds. With specialized tagged accounts, tagged funds (to be traced) would be permitted to be distributed. The first computing system (e.g., World Bank) sends a request, via an acquirer, to a processing server, requesting creation of a first tagged blockchain account that is configured to store tagged funds. For example, the first computing system (e.g., World Bank) may send a request to the processing server to create the first tagged blockchain account and transfer $250,000 for storage therein. In order to receive tagged funds, the second computing system (e.g., Red Cross) also has a specialized account and, thus, also sends a request, to the processing server, requesting creation of a tagged blockchain (second tagged blockchain account). The processing server creates the first and second tagged blockchain accounts on a blockchain running in parallel with a payment gateway service maintained by the processing server. When the first computing system (e.g., World Bank) is ready to disburse funds, it transmits a disbursement request to the processing server. The disbursement request identifies the second computing system (e.g., Red Cross) and an amount of tagged funds it would like to disburse from the tagged funds stored in its tagged blockchain account. For example, the first computing system (e.g., World Bank) may identify the second computing system (e.g., Red Cross) and indicate that it would like to disburse $200,000 to the Red Cross's tagged blockchain account. Concurrent with the transferring of the tagged funds ($200,000) from the first tagged blockchain account (associated with the World Bank) to the second tagged blockchain account (associated with the Red Cross), the processing server creates a genesis block on the blockchain that includes a unique identifier tag assigned to the received disbursement request. The processing server also stores details associated with the disbursement of tagged funds in the genesis block. Once the second computing system (e.g., Red Cross) receives the funds, it may further distribute them to intended recipients. For each of those distributions to recipients, a new transaction is initiated that includes the unique identifier tag and, thus, another block is added to the blockchain that is tagged back to the genesis block. In other words, any new transaction associated with the original distribution of funds can be traced back to the genesis block (via the unique identifier tag) with every transaction in between occurring in intervening blocks.

By enabling the processing server, which assists in the processing of traditional payment transactions using payment rails, to create special tagged blockchain accounts on the blockchain, an immutable record of a flow path of funds may be established that enables the funds to intended recipients to be easily traced without any chance of corruption and without having to modify existing transaction processes and/or architecture.

A method for creating traceability within a network system, the method includes: receiving, by a processing server, a first account request message, from a first computing system, wherein said account request message (i) requests creation of a first tagged blockchain account configured to store at least a first amount of tagged funds and (ii) includes an identifier associated with the first computing system and the first amount of tagged funds; creating, by the processing server, the first tagged blockchain account on a blockchain stored on a blockchain network, said blockchain running in parallel with a payment gateway service maintained by the processing server; receiving, by the processing server, a second account request message, from a second computing system, wherein said second account request message (i) requests creation of a second tagged blockchain account configured to receive tagged funds and (ii) includes an identifier associated with the second computing system; creating, by the processing server, the second tagged blockchain account on the blockchain; once the processing server creates the first and second tagged blockchain accounts, receiving, by the processing server, from the first computing system, a disbursement request that identifies (i) an account identifier associated with the first tagged blockchain account, (ii) an account identifier associated with the second tagged blockchain account, and (iii) a second amount of tagged funds; transferring, by the processing server, the second amount of tagged funds from the first amount of tagged funds in the first tagged blockchain account to the second tagged blockchain account; and concurrent with the transferring of the second amount of tagged funds, creating, by the processing server, a genesis block on the blockchain that includes a unique identifier tag assigned to the received disbursement request and disbursement details associated with the disbursement of the second amount of tagged funds.

A network system for creating traceability including: a processing server; a first computing system; a second computing system; and a blockchain network. The processing server includes a processor and a memory storing instructions thereon that when executed by the processor cause the processor to receive a first account request message, from the first computing system, wherein said account request message (i) requests creation of a first blockchain account configured to store at least a first amount of tagged funds and (ii) includes an identifier associated with the first computing system and the first amount of tagged funds; create the first tagged blockchain account on a blockchain running in parallel with a payment gateway service maintained by the processing server; receive a second account request message, from the second computing system, wherein said second account request message (i) requests creation of a second tagged blockchain account configured to receive tagged funds and (ii) includes an identifier associated with the second computing system; create the second tagged blockchain account on the blockchain; receive, once the first and second tagged blockchain accounts are created, a disbursement request from the first computing system, wherein the disbursement request identifies (i) a second amount of tagged funds, (ii) an account identifier associated with the first tagged blockchain account, and (iii) an account identifier associated with the second tagged blockchain account; transfer the second amount of tagged funds from the first amount of tagged funds in the first tagged blockchain account to the second tagged blockchain account; and create, concurrent with the transferring of currency, a genesis block on the blockchain that includes (i) a unique identifier tag assigned to the disbursement request and (ii) disbursement details associated with the disbursement of the second amount of tagged funds.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high-level system architecture for enabling blockchain based traceability of immutable transactions in accordance with exemplary embodiments.

FIG. 2 is a block diagram illustrating a processing server of the system of FIG. 1 for enabling blockchain based traceability of immutable transactions in accordance with exemplary embodiments.

FIG. 3 is a flow diagram illustrating a process for creating a tagged blockchain account for a fund source organization in accordance with exemplary embodiments.

FIG. 4 is a flow diagram illustrating a process for creating a tagged blockchain account for a recipient organization of distributed funds in accordance with exemplary embodiments.

FIG. 5 is a flow diagram illustrating a process for fund disbursement from a funding organization to a recipient organization in accordance with exemplary embodiments.

FIG. 6 is a flow chart illustrating an exemplary method for creating traceability within a network system in accordance with exemplary embodiments.

FIG. 7 is an example of a blockchain wallet in accordance with exemplary embodiments.

FIG. 8 is a block diagram illustrating a computer system architecture in accordance with exemplary embodiments.

Further areas of applicability of the present disclosure will become apparent from the detailed description provided hereinafter. It should be understood that the detailed description of exemplary embodiments is intended for illustration purposes only and is, therefore, not intended to necessarily limit the scope of the disclosure.

### GLOSSARY OF TERMS

Blockchain—A public ledger of all transactions of a blockchain-based currency. One or more computing devices may comprise a blockchain network, which may be configured to process and record transactions as part of a block in the blockchain. Once a block is completed, the block is added to the blockchain and the transaction record thereby updated. In many instances, the blockchain may be a ledger of transactions in chronological order or may be presented in any other order that may be suitable for use by the blockchain network. In some configurations, transactions recorded in the blockchain may include a destination address and a currency amount, such that the blockchain records how much currency is attributable to a specific address. In some instances, the transactions are financial and others not financial, or might include additional or different information, such as a source address, timestamp, etc. In some embodiments, a blockchain may also or alternatively include nearly any type of data as a form of transaction that is or needs to be placed in a distributed database that maintains a continuously growing list of data records hardened against tampering and revision, even by its operators, and may be confirmed and validated by the blockchain network through proof of work and/or any other suitable verification techniques associated therewith. In some cases, data regarding a given transaction may further include additional data that is not directly part of the transaction appended to transaction data. In some instances, the inclusion of such data in a blockchain may constitute a transaction. In such instances, a blockchain may not be directly associated with a specific digital, virtual, fiat, or other type of currency.

### DETAILED DESCRIPTION

### System for Creating Traceability of Immutable Transactions

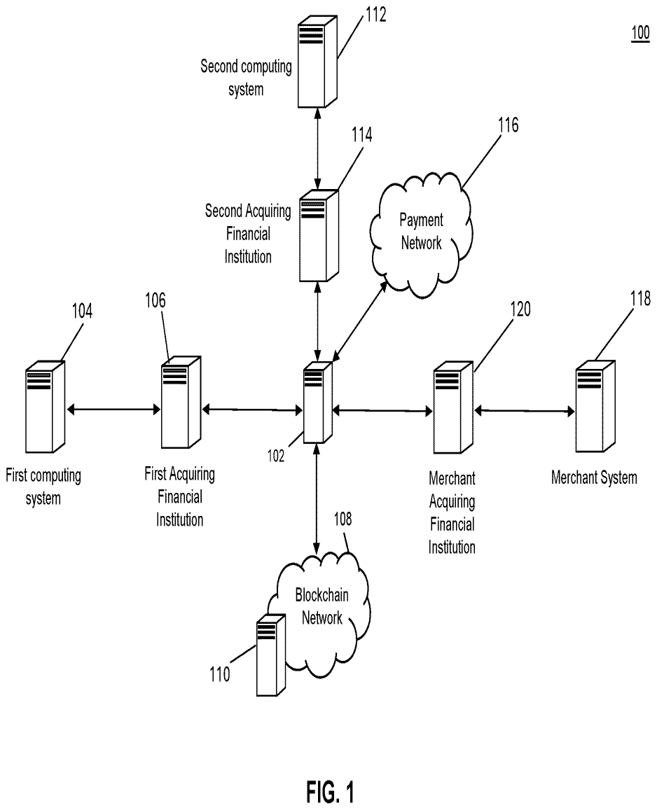

FIG. 1 illustrates a system 100 for enabling blockchain based traceability of immutable transactions. The system 100 includes a processing server 102, a payment network 116, a blockchain network 108, a first computing system 104, a first acquiring a financial institution 106, a second computing system 112, a second acquiring financial institution 114, a merchant system 118, and a merchant acquiring financial institution 120.

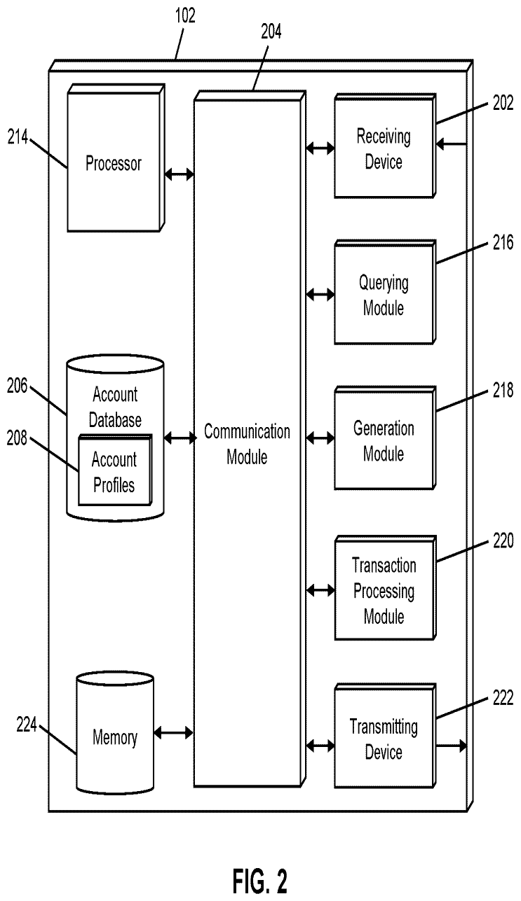

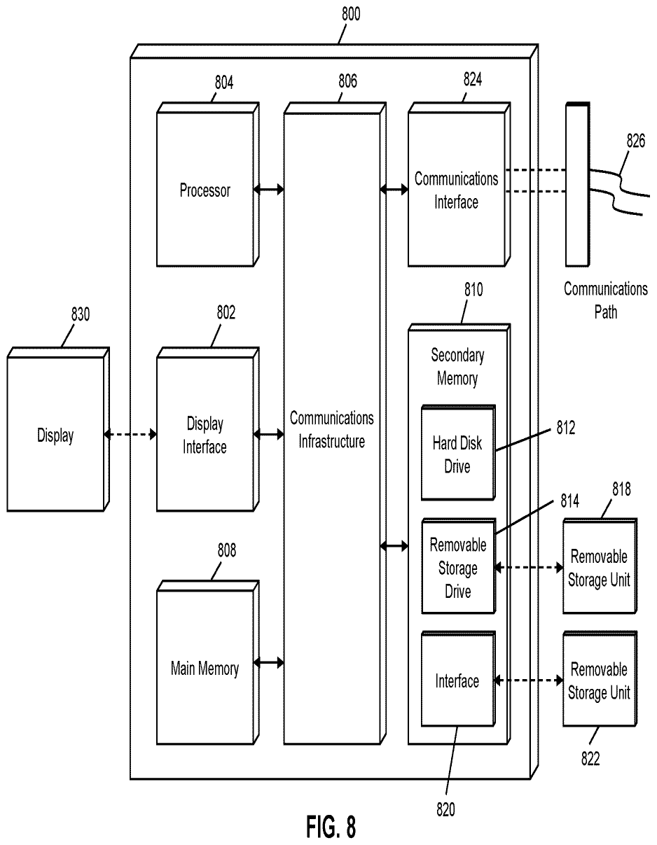

The processing server 102, discussed in more detail below, can be a computing system, such as illustrated in FIGS. 2 and 8, discussed in more detail below, that is configured to assist in the creation of tagged blockchain accounts, the processing of payment transactions using payment rails and to access a blockchain on a blockchain network 108 to create blocks thereon. The processing server 102 manages a payment gateway that runs in parallel with the blockchain network 108. The processing server 102 monitors the state of the blockchain and can cause transactions to be written to the blockchain. The processing server 102 may be an external entity to the payment network 116, as illustrated in FIG. 1, or it may be a node/component within the payment network 116.

The blockchain network 108 runs in parallel with the processing server 102 (e.g., payment gateway service managed by the processing server) and can be comprised of a plurality of blockchain nodes 110. While FIG. 1 depicts a single blockchain node 110, it is understood that the blockchain network 108 may include a plurality of blockchain nodes. Each blockchain node 110 can be a computing system, such as illustrated in FIG. 8, discussed in more detail below, that is configured to perform functions related to the processing and management of the blockchain, including the generation of blockchain data values, verification of proposed blockchain transactions, verification of digital signatures, generation of new blocks, validation of new blocks, maintenance of a copy of the blockchain, etc.

The blockchain may be a distributed ledger that is comprised of at least a plurality of blocks. Each block can include at least a block header and one or more data values. Each block header can include at least a timestamp, a block reference value, a data reference value, and a unique identifier tag. The timestamp can be a time at which the block header was generated and can be represented using any suitable method (e.g., UNIX timestamp, DateTime, etc.). The block reference value can be a value that references an earlier block (e.g., based on timestamp) in the blockchain. In some embodiments, a block reference value in a block header can be a reference to the block header of the most recently added block prior to the respective block. In an exemplary embodiment, the block reference value can be a hash value generated via the hashing of the block header of the most recently added block. The data reference value can similarly be a reference to the one or more data values stored in the block that includes the block header. In an exemplary embodiment, the data reference value can be a hash value generated via the hashing of the one or more data values. For instance, the block reference value can be the root of a Merkle tree generated using the one or more data values. The unique identifier tag is associated with a transaction that has processed via traditional payment rails and is used to create traceability of funds from source to recipient.

The use of the block reference value and data reference value in each block header can result in the blockchain being immutable. Any attempted modification to a data value would require the generation of a new data reference value for that block, which would thereby require the subsequent block's block reference value to be newly generated, further requiring the generation of a new block reference value in every subsequent block. This would have to be performed and updated in every single blockchain node 110 in a blockchain network 108 prior to the generation and addition of a new block to the blockchain in order for the change to be made permanent. Depending on the blockchain, computational and communication limitations may make such a modification exceedingly difficult, if not impossible, thus rendering the blockchain immutable.

In some embodiments, the blockchain can be used to store information regarding transactions conducted between two different blockchain wallets. A blockchain wallet can include a private key of a cryptographic key pair that is used to generate digital signatures that serve as authorization by a payer for a transaction, where the digital signature can be verified by the respective blockchain network 108 using the public key of the cryptographic key pair. In some cases, the term “blockchain wallet” can refer specifically to the private key. In other cases, the term “blockchain wallet” can refer to a computing device (e.g., of a consumer) that stores the private key for use thereof in transactions. For instance, each computing device can have their own private key for respective cryptographic key pairs and can each be a blockchain wallet for use in transactions with the blockchain associated with the blockchain network. Computing devices can be any type of device suitable to store and utilize a blockchain wallet, such as a desktop computer, laptop computer, notebook computer, tablet computer, cellular phone, smart phone, smart watch, smart television, wearable computing device, implantable computing device, etc.

In the system 100, the blockchain may be used to store data related to the disbursement of funds from one computing system (e.g., first computing system 104) to another computing system (e.g., second computing system 112) and the subsequent use of the transferred funds in transactions. The blockchain can ensure that funds distributed by the first computing system 104 (e.g., government, organization, etc.) is 100% received by the intended recipients with no or little chance of corruption, diversion of funds or fraud.

Traditionally, a payment transaction is processed by a payment network (e.g., payment network 116). As discussed herein, the term “payment network” can refer to a system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by Mastercard®, VISA®, Discover®, American Express®, PayPal®, etc. Use of the term “payment network” herein may refer to both the payment network as an entity, and the physical payment network, such as the equipment, hardware, and software comprising the payment network. However, in instances where funds are distributed from one entity (first computing system 104) to a second entity (second computing system 112) for further distribution to recipients, a traditional payment network (such as payment network 116) is not configured to trace the distribution of funds. For example, suppose the World Bank distributes X amount of funds to the Red Cross to be distributed to individuals in need, there currently is no adequate mechanism to trace the funds and to whom those funds are distributed from the Red Cross. The system 100 leverages a blockchain stored in the blockchain network 108 to create traceability by tagging financial transactions (discussed in more detail herein).

The first computing system 104 can be a computing system, such as illustrated in FIG. 8, discussed in more detail below, that is configured to transfer funds for use by the second computing system 112. The first computing system 104 may be, for example, a government entity, a financial institution, an organization, etc. The first computing system 104 communicates with the processing server 102 or an acquirer 106 (first acquiring financial institution) of the processing server 102 to request a first tagged blockchain account that is configured to store tagged funds. For example, the first computing system 104 (e.g., World Bank) may send a request to the processing server 102 to create the first tagged blockchain account and transfer $250,000 for storage therein. In some embodiments, the tagged funds may be included in the request from the first computing system 104. In other embodiments, the tagged funds may be included in a subsequent communication, after creation of the first tagged blockchain account. The processing server 102 then creates the first tagged blockchain account on the blockchain and stores the funds (received from the first computing system 104) thereon. The first tagged blockchain account includes at least an identifier associated with the first computing system 104 and the amount of funds (e.g., $250,000) received from the first computing system 104.

The second computing system 112 (e.g., Red Cross) can be a computing system, such as illustrated in FIG. 8, discussed in more detail below, that is configured to receive funds disbursed by the second computing system 112. The second computing system 112 (e.g., Red Cross) is notified that the first computing system 104 (e.g., World Bank) would like to disburse funds thereto. A notification may be sent by the processing server 102 to the second computing system 112 once it creates the first tagged blockchain account of the first computing system 104 (e.g., World Bank) and receives the associated funds. Alternatively, the notification may be sent directly from the first computing system 104 (e.g., World Bank). The notification indicates that the second computing system 112 (e.g., Red Cross) must create a tagged account in order to receive tagged funds from the first computing system 112 (e.g., World Bank). The second computing system 112 communicates with the processing server 102 or an acquirer 114 (second acquiring financial institution) of the processing server 102 to request a second tagged blockchain account that is configured to receive tagged funds. For example, the second computing system 112 (e.g., Red Cross) may send a request to the processing server 102 to create the second tagged blockchain account The processing server 102 then creates the second tagged blockchain account on the blockchain. The second tagged blockchain account includes at least an identifier associated with the second computing system 112. Once the first and second tagged blockchain accounts are created, the processing server 102 receives, from the blockchain network 108, first account information associated with the created first tagged blockchain account and second account information associated with the created second tagged blockchain account including at least first and second account identifiers (associated with the first and second tagged blockchain accounts, respectively) as well as any additional information necessary for the creation of the respective tagged blockchain accounts. The processing server 102 may then store respective account profiles 208 in an account database 206 (described in more detail with respect to FIG. 2).

Once the processing server 102 creates the first and second tagged blockchain accounts, receives the tagged funds from the first computing system 104, and stores the tagged funds in the first tagged blockchain account associated with the first computing system 104, it is then configured to disburse funds from the first tagged blockchain account associated with the first computing system 104 to the second tagged blockchain account associated with the second computing system 112. In some embodiments, the first computing system 104 (e.g., World Bank) may transmit a disbursement request to the processing server 102 that identifies the second computing system 112 (e.g., Red Cross) and an amount of tagged funds it would like to disburse from the tagged funds stored in its tagged blockchain account. For example, the first computing system 104 (e.g., World Bank) may identify the second computing system (e.g., Red Cross) and indicate that it would like to disburse $200,000 from the $250,000 stored in the first tagged blockchain account to the Red Cross's tagged blockchain account. The processing server 102 would then transfer the $200,000 from the first tagged blockchain account associated with the first computing system 104 to the second tagged blockchain account associated with the second computing system 112.

The processing server 104 is also configured to communicate with the blockchain network 108, concurrent with the transferring of the tagged funds ($200,000) from the first tagged blockchain account (associated with the first computing system 104) to the second tagged blockchain account (associated with the second computing system 112) and create a genesis block on the blockchain (i.e., the very first block created for that blockchain). In some embodiments, the genesis block may include a direct copy of the disbursement (e.g., same inputs, addresses, amounts, etc.). The genesis block may be added to the blockchain and may include a flag or other indication indicating that it is a new genesis block. The genesis block may further include a unique identifier tag, which is assigned to or is associated with the disbursement request received from the first computing system 104 and/or transfer of funds from the first tagged blockchain account to the second tagged blockchain account.

The processing server 102 may also store details associated with the disbursement of tagged funds in the genesis block. The details may include, for example, an identifier of the first computing system 104, an identifier associated with the second computing system 112, a timestamp associated with the day/time of the disbursement of funds to the second tagged account of the second computing system 112, the amount of funds disbursed to the second tagged account of the second computing system 112, etc.

Once the second computing system 112 (e.g., Red Cross) receives the tagged funds, it may further distribute them to intended recipients (e.g., beneficiaries). For each of those distributions to recipients, a new transaction may be initiated that includes the unique identifier tag and, thus, another block is added to the blockchain that is tagged back to the genesis block. For example, in one embodiment, the processing server 102 (or second acquiring financial institution 114) may issue payment cards to the second computing system 112 (e.g., Red Cross). A payment card may be, for example, a limited-use card (with controls associated therewith) that enables the recipient access to only a limited amount of funds from the second blockchain account of the second computing system 112. For example, the payment card may include a payment account identifier associated with an account identifier associated with the second blockchain account and may only be used at specific merchants up to a predetermined amount. In one instance, a user may use the payment card at merchant system 118 in a transaction for the purchase of goods and/or services. The merchant system 118 (e.g., a third computing system) may transmit a transaction authorization request for the transaction to the processing server, via the merchant acquiring financial institution 120. The transaction authorization request may include a plurality of data fields, including at least (i) a first data field storing a payment account identifier associated with the second tagged blockchain account, (ii) a second data field storing a payment amount, (iii) a third data field storing a specialized tag (indicating that it is using specialized tagged funds), and (iv) a fourth data field storing a merchant account identifier associated with the merchant system 118. Upon receiving the transaction authorization request, the processing server 102 would process the transaction between the recipient and the merchant system 118 by communicating with the payment network 116. The processing server 102 would also detect the specialized tag included in the transaction authorization request prompting the processing server 102 to communicate with the blockchain network 108 to identify an associated blockchain. The processing server 102 would identify the genesis block stored on the blockchain based on the specialized tag in the transaction request message matching the unique identifier tag of the genesis block. The processing server 102 would then create a second block in the blockchain including the unique identifier tag and transaction details associated with the transaction. This way, the transaction between the user and the merchant system 118 using the tagged funds originally distributed by the first computing system would be traced back to the genesis block (i.e., first block including details of the disbursement of funds).

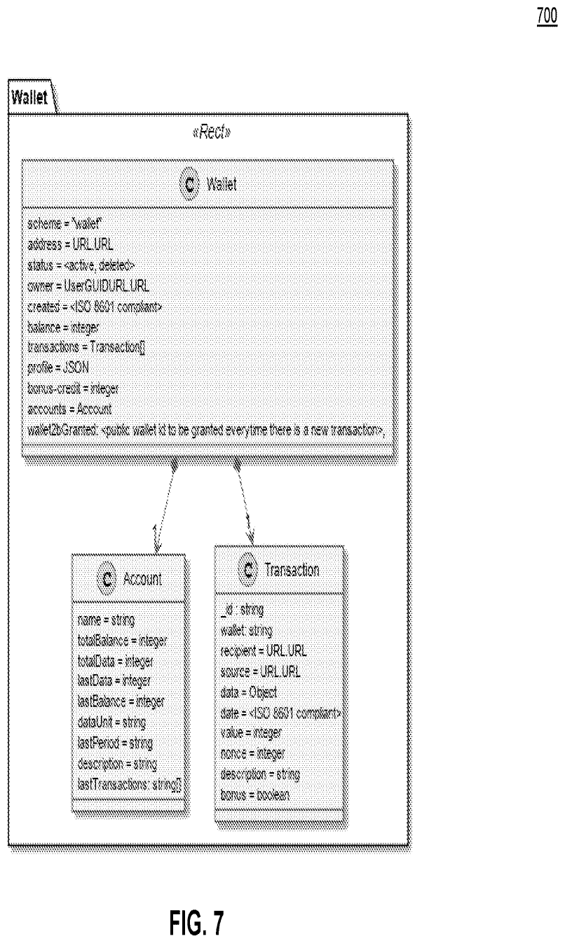

In another embodiment, once the second computing system 112 (e.g., Red Cross) receives the funds, it may further distribute funds to intended recipients via blockchain wallets. For example, the processing server 102 may transfer a third amount of tagged funds (e.g., $5000) from the second amount of tagged funds ($200,000) in the second tagged blockchain account to a blockchain wallet associated with a consumer. An example of such a blockchain wallet is depicted in FIG. 7. The processing server 102 would then create a second block in the blockchain that includes the unique identifier tag and details associated with the transferring of the third amount of tagged funds to the blockchain wallet. When the consumer initiates a transaction with a third computing system (e.g., merchant system 118) using the blockchain wallet, the merchant system 118 would submit a transaction request message for the transaction to the processing server 102. The transaction request message would include a plurality of data fields, including at least (i) a first data field storing a payment account identifier associated with the consumer's blockchain wallet, (ii) a second data field storing a payment amount, and (iii) a third data field storing a specialized tag. In response to detecting the specialized tag, the processing server 102 would identify the genesis block and the second block stored on the blockchain based on the specialized tag in the transaction request message matching the unique identifier tag of the genesis block and second block. The processing server 102 would then create a third block in the blockchain including the unique identifier tag and transaction details associated with the transaction so the transaction with the merchant would be traced back to the original genesis block.

The methods and systems discussed herein provide a system that combines traditional payment rails (payment network 116) with a blockchain network 106 where a blockchain runs in parallel with a payment gateway service managed by a processing server 102 in order to create immutable traceability by tagging financial transactions at a source to ensure noninterference. By enabling the processing server 102 to utilize a traditional payment network (such as payment network 116) and payment systems technologies to process a transaction in combination with utilizing a blockchain provides the technological benefits of both quick processing times (provided by the traditional payment network—often measured in nanoseconds) and a decentralized blockchain to create immutable traceability. As a result, funds distributed by a funding entity would be guaranteed to be received by intended recipients and would be traceable, and any modifications or prohibited transactions would be automatically invalidated.

### Processing Server

FIG. 2 illustrates an embodiment of the processing server 102 of the network system 100 of FIG. 1. It will be apparent to persons having skill in the relevant art that the embodiment of the processing server 102 illustrated in FIG. 2 is provided as illustration only and cannot be exhaustive to all possible configurations of the processing server 102 suitable for performing the functions as discussed herein. For example, the computer system 800 illustrated in FIG. 8 and discussed in more detail below can be a suitable configuration of the processing server 102.

The processing server 102 may include a receiving device 202. The receiving device 202 may be configured to receive data over one or more networks via one or more network protocols. In some instances, the receiving device 202 may be configured to receive data from the first acquiring financial institutions 106, directly from the first computing system 104, the second acquiring financial institution 114, directly from the second computing system 112, payment network 116 merchant acquiring financial institution 120, directly from merchant system 118, blockchain network 108, and other systems and entities via one or more communication methods, such as radio frequency, local area networks, wireless area networks, cellular communication networks, Bluetooth, the Internet, etc. In some embodiments, the receiving device 202 may be comprised of multiple devices, such as different receiving devices for receiving data over different networks, such as a first receiving device for receiving data over a local area network and a second receiving device for receiving data via the Internet. The receiving device 202 may receive electronically transmitted data signals, where data can be superimposed or otherwise encoded on the data signal and decoded, parsed, read, or otherwise obtained via receipt of the data signal by the receiving device 202. In some instances, the receiving device 202 may include a parsing module for parsing a received data signal to obtain the data superimposed thereon. For example, the receiving device 202 may include a parser program configured to receive and transform the received data signal into usable input for the functions performed by the processing device/processor 214 to carry out the methods and systems described herein.

The receiving device 202 may be configured to receive data signals electronically transmitted from the first computing system 104, via the first acquiring financial institution 106 that can be superimposed or otherwise encoded with account request messages and disbursement requests. The account request messages can be superimposed or otherwise encoded with an identifier associated with the first computing system 104, a first amount of tagged funds, and any other suitable data necessary to create a first tagged blockchain account configured to store at least the first amount of tagged funds. The disbursement requests can be superimposed or otherwise encoded with an account identifier associated with the first tagged blockchain account, an account identifier associated with a second tagged blockchain account, and a second amount of tagged funds. The receiving device 202 may also be configured to receive data signals electronically transmitted from the second computing system 112, via the second acquiring financial institution 114 that can be superimposed or otherwise encoded with account request messages. The account request messages received from the second computing system can be superimposed or otherwise encoded with an identifier associated with the second computing system 112. The receiving device 202 may further be configured to receive data signals electronically transmitted by nodes 110 of the blockchain network 108, which can be superimposed or otherwise encoded with created tagged blockchain account information. The receiving device 202 may also be configured to receive data signals electronically transmitted by merchant system 118, via merchant acquiring financial institution 120, which can be superimposed or otherwise encoded with transaction authorization requests.

The processing server 109 may also include a communication module 204. The communication module 204 may be configured to transmit data between modules, engines, databases, memories, and other components of the processing server 109 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc.

The processing server 109 may also include a processing device/processor 214. The processing device 214 may be configured to perform the functions of the processing server 102 discussed herein as will be apparent to persons having skill in the relevant art. In some embodiments, the processing device 214 may include and/or be comprised of a plurality of engines and/or modules specially configured to perform one or more functions of the processing device 214, such as a querying module 216, generation module 218, etc. As used herein, the term “module” may be software or hardware particularly programmed to receive an input, perform one or more processes using the input, and provides an output. The input, output, and processes performed by various modules will be apparent to one skilled in the art based upon the present disclosure.

The processing server 102 may also include a memory 224. The memory 224 may be configured to store data for use by the processing server 102 in performing the functions discussed herein, such as public and private keys, symmetric keys, etc. The memory 224 can be configured to store data using suitable data formatting methods and schema and can be any suitable type of memory, such as read-only memory, random access memory, etc. The memory 224 can include, for example, encryption keys and algorithms, communication protocols and standards, data formatting standards and protocols, program code for modules and application programs of the processing device, and other data that can be suitable for use by the processing server 102 in the performance of the functions disclosed herein as will be apparent to persons having skill in the relevant art. In some embodiments, the memory 224 can be comprised of or can otherwise include a relational database that utilizes structured query language for the storage, identification, modifying, updating, accessing, etc. of structured data sets stored therein. The memory 224 can be configured to store, for example, transaction account maps, device profiles, cryptographic keys including public keys and/or private keys, communication data, encryption algorithms, scoring algorithms, machine learning algorithms, pattern-matching algorithms, transaction data, transaction message standards, transaction message formatting rules, etc.

The processing server 102 may include a querying module 216. The querying module 216 may be configured to execute queries on databases to identify information. The querying module 216 may receive one or more data values or query strings and can execute a query string based thereon on an indicated database. For example, the querying module 216 may execute a query on the memory 224, the account database (discussed in more detail herein), and the blockchain stored on the blockchain network 108. The querying module 216 may then output the identified information to an appropriate engine or module of the processing server 102 as necessary.

The processing server 102 may also include a generation module 218. The generation module 218 may be configured to generate data for use by the processing server 102 in performing the functions discussed herein. The generation module 218 may receive instructions as input, may generate data based on the instructions, and may output the generated data to one or more modules of the processing server 102. For example, the generation module 218 may be configured to generate transaction messages, notification messages, etc.

The processing server 102 may also include a transaction processing module 220. The transaction processing module 220 may be configured to perform functions related to the processing of payment transactions including the formatting of transaction messages, forwarding of transaction messages, determination of compliance with transaction controls, etc. The transaction processing module 220 may receive instructions and data as input, may perform one or more functions as instructed, and may output the result to another module or engine of the processing server. The transaction processing module 220 may, for example, be configured to determine if one or more transaction controls are complied with for an e-commerce payment transaction based on the transaction details, etc.

The processing server 102 may also include a transmitting device 222. The transmitting device 222 may be configured to transmit data over one or more networks via one or more network protocols. In some instances, the transmitting device 222 may be configured to transmit data to the blockchain network 108, to the first computing system 104, via the first acquiring financial institution 106, to the second computing system 112, via the second acquiring financial institution 114, to the payment network 116, to the merchant system 118, via the merchant acquiring financial institution 120, and to other entities via one or more communication methods, local area networks, wireless area networks, cellular communication, Bluetooth, radio frequency, the Internet, etc. In some embodiments, the transmitting device 220 may be comprised of multiple devices, such as different transmitting devices for transmitting data over different networks, such as a first transmitting device for transmitting data over a local area network and a second transmitting device for transmitting data via the Internet. The transmitting device 222 may electronically transmit data signals that have data superimposed that can be parsed by a receiving computing device. In some instances, the transmitting device 222 may include one or more modules for superimposing, encoding, or otherwise formatting data into data signals suitable for transmission.

The processing server 102 may also include an account database 206. The account database 206 may be configured to store one or more account profiles 208 using a suitable data storage format and schema. The account database 206 may be a relational database that utilizes structured query language for the storage, identification, modifying, updating, accessing, etc. of structured data sets stored therein. Each account profile 208 may be a structured data set configured to store data related to a transaction account. An account profile 208 may include, for example, an account identifier, a transaction account number, etc.

### Process for Creating Tagged Blockchain Account for Fund Source Organization

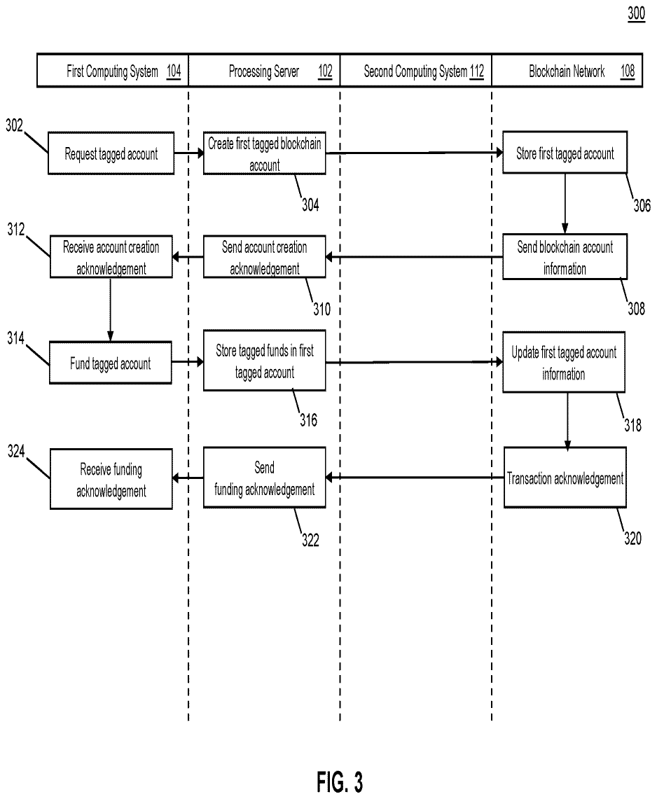

FIG. 3 illustrates a process 300 for creating a tagged blockchain account for a fund source organization.

In step 302, the first computing system 104 (e.g., World Bank) may send a request for a tagged blockchain account (configured to receive tagged funds) to the processing server 102. In step 304, the processing server 102 communicates (via transmitting device 222) with the blockchain network 108 and creates a first tagged blockchain account thereon that is associated with the first computing system 104 (e.g., World Bank) and, at step 306, the blockchain network 108 stores the first tagged blockchain account. At step 308, the blockchain network 108 sends blockchain account information associated with the first tagged blockchain account to the processing server 102. At step 310, the processing server 102 sends (via transmitting device 222) an account creation acknowledgement to the first computing system 104 (e.g., World Bank). At step 314, the first computing system 104 then funds the tagged account by sending funds to the processing server 102. The processing server, at step 316, stores the tagged funds in the first tagged blockchain account and, at step 318, the blockchain network 108 updates the first tagged blockchain account information. At step 320, the blockchain network 108 sends a transaction acknowledgement to the processing server 102. At step 322, the processing server 102 sends (via transmitting device 222) a funding acknowledgement to the first computing system 104 and, at step 324, the first computing system 104 receives the funding acknowledgment from the processing server 102.

### Process for Creating Tagged Blockchain Account for Recipient Organization

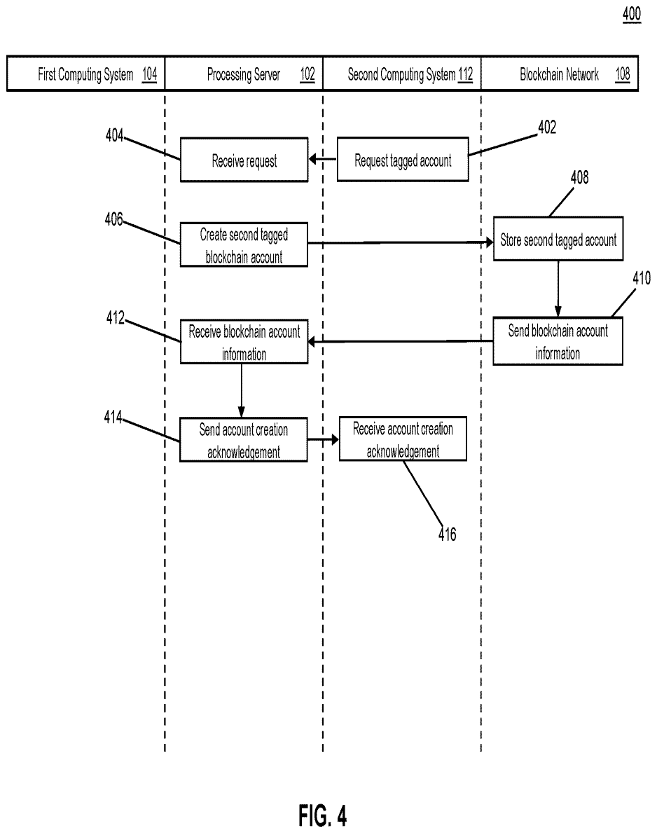

FIG. 4 illustrates a process 400 for creating a tagged blockchain account for a recipient organization of distributed funds.

In step 402, the second computing system 112 (e.g., Red Cross) sends a request to the processing server 102 to create a tagged blockchain account. At step 404, the processing server receives the request (via receiving device 202) and, at step 406, communicates (via transmitting device 222) with the blockchain network 108 to create a second tagged blockchain account associated with the second computing system 112 (e.g., Red Cross). At step 408, the blockchain network 108 stores the second tagged blockchain account and, at step 410, sends blockchain account information associated with the second tagged blockchain account to the processing server 102. At step 412, the processing server 102 receives (via receiving device 202) the blockchain account information associated with the second tagged blockchain account and sends (via transmitting device 222), at step 414, an account creation acknowledgement to the second computing system 112 (e.g., Red Cross). The second computing system 112 (e.g., Red Cross) receives the account creation acknowledgement at step 416.

### Process for Fund Disbursement from Funding Organization to Recipient Organization

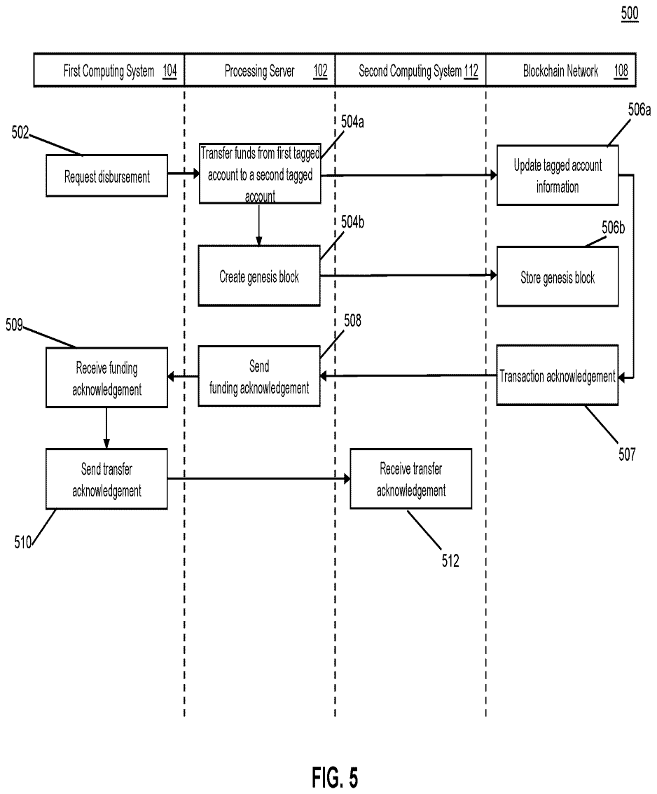

FIG. 5 illustrates a process 500 for fund disbursement from a funding organization (e.g., World Bank) to a recipient organization (e.g., Red Cross).

In step 502, the first computing system 104 (e.g., World Bank) sends a disbursement request to the processing server 102. The disbursement request identifies an amount of tagged funds to be disbursed from the first tagged blockchain account to the second computing system 112 (e.g., Red Cross). At step 504a, the processing server 102 transfers the identified amount of funds from the first tagged blockchain account associated with the first computing system 104 (e.g., World Bank) to the second tagged blockchain account associated with the second computing system 112 (e.g., Red Cross). Concurrently with step 504a, at step 504b, the processing server 102 creates a genesis block on the blockchain that includes a unique identifier tag assigned to the received disbursement request and disbursement details associated with the disbursement of the identified amount of tagged funds. At steps 506a and 506b, the blockchain network 108 updates the respective first and second tagged blockchain accounts and stores the genesis block. At step 507, the blockchain network 108 transmits a transaction acknowledgement to the processing server 102. At step 508, the processing server 102 receives (via receiving device 202) the transaction acknowledgement from the blockchain network 108 and sends (via transmitting device 222) a funding acknowledgement to the first computing system 104 (e.g., World Bank). At step 510, the first computing system 104 (e.g., World Bank) sends a transfer acknowledgement to the second computing system 112 (e.g., Red Cross) and, at step 512, the second computing system 112 (e.g., Red Cross) receives the transfer acknowledgement.

### Exemplary Method for Creating Traceability within a Network System

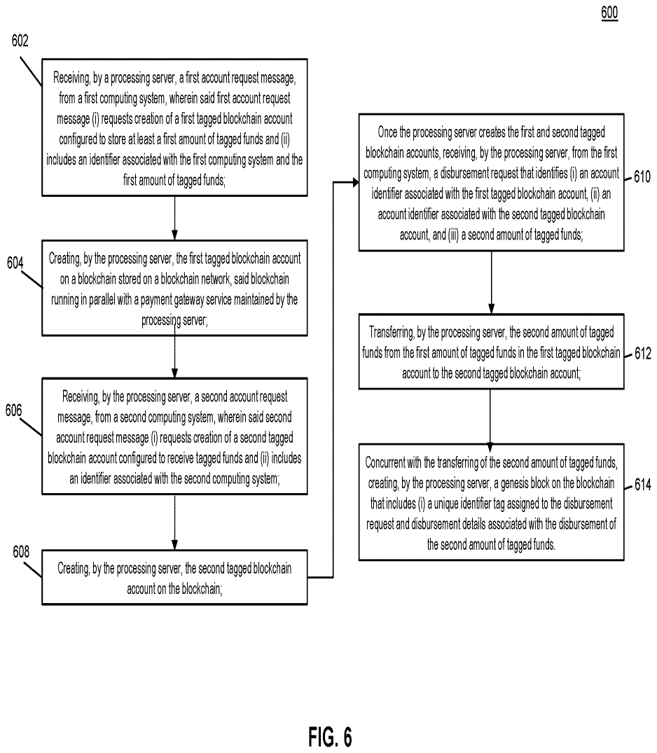

FIG. 6 illustrates a method 600 for creating traceability within the network system 100 of FIG. 1.

In step 602, receiving, by a processing server (e.g., via receiving device 202 of processing server 102), a first account request message, from a first computing system (e.g., first computing system 104), wherein said account request message (i) requests creation of a first tagged blockchain account configured to store at least a first amount of tagged funds and (ii) includes an identifier associated with the first computing system (e.g., first computing system 104) and the first amount of tagged funds.

In step 604, creating, by the processing server (e.g., processing server 102), the first tagged blockchain account on a blockchain stored on a blockchain network (e.g., blockchain network 108), said blockchain running in parallel with a payment gateway service maintained by the processing server (e.g., processing server 102). In step 606, receiving, by the processing server (e.g., via receiving device 202 of processing server 102), a second account request message, from a second computing system (e.g., second computing system 112), wherein said second account request message (i) requests creation of a second tagged blockchain account configured to receive tagged funds and (ii) includes an identifier associated with the second computing system (e.g., second computing system 112).

In step 608, creating, by the processing server, the second tagged blockchain account on the blockchain in the blockchain network 108. In step 610, once the processing server (e.g., processing server 102) creates the first and second tagged blockchain accounts, receiving, by the processing server (via receiving device 202 of processing server 102) from the first computing system (e.g., first computing system 104), a disbursement request that identifies (i) an account identifier associated with the first tagged blockchain account, (ii) an account identifier associated with the second tagged blockchain account, and (iii) a second amount of tagged funds.

In step 612, transferring, by the processing server (e.g., processing server 102), the second amount of tagged funds from the first amount of tagged funds in the first tagged blockchain account to the second tagged blockchain account; and, in step 614, concurrent with the transferring of the second amount of tagged funds, creating, by the processing server (e.g., processing server 102), a genesis block on the blockchain that includes a unique identifier tag assigned to the received disbursement request and disbursement details associated with the disbursement of the second amount of tagged funds.

In some embodiments, the method may further include receiving, by the processing server (e.g., processing server 102), from a third computing system (e.g., merchant system 118), a transaction request message for a transaction, wherein the transaction request message includes a plurality of data fields. The data fields include at least (i) a first data field storing a payment account identifier (e.g., associated with a payment card used in the transaction), (ii) a second data field storing a payment amount, (iii) a third data field storing a specialized tag, and (iv) a fourth data field storing a recipient account identifier (e.g., merchant payment account). In response to detecting the specialized tag in the transaction request, the method may also include (i) executing a query, on the blockchain, and identifying the second tagged blockchain account based on the payment account identifier included in the transaction request message matching the second account identifier of the second tagged blockchain account, and (ii) processing, by the processing server (e.g., processing server 102), the transaction between a recipient transaction account associated with the recipient account identifier and the second tagged blockchain account for the payment amount.

In yet other embodiments, the blockchain may store payment account and blockchain wallet information associated with a consumer to whom funds have been distributed via the second computing system 112 (e.g., Red Cross). In such embodiments, the method may further include transferring, by the processing server (e.g., processing server 102), a third amount of tagged funds from the second amount of tagged funds in the second tagged blockchain account associated with the second computing system 112 (e.g., Red Cross) to a blockchain wallet associated with the consumer and creating, by the processing server (e.g., processing server 102), a second block in the blockchain, wherein the second block includes the unique identifier tag and details associated with the transferring of the third amount of tagged funds. An example of such a blockchain wallet associated with the consumer is illustrated in FIG. 7.

### Computer System Architecture

FIG. 8 illustrates a computer system 800 in which embodiments of the present disclosure, or portions thereof, can be implemented as computer-readable code. For example, the processing server 102, blockchain nodes 110, first and second computing systems 104, 112, first and second acquiring financial institutions 106, 114, merchant system 118, and merchant acquiring financial institution 120 can be implemented in the computer system 800 using hardware, non-transitory computer readable media having instructions stored thereon, or a combination thereof and can be implemented in one or more computer systems or other processing systems. Hardware can embody modules and components used to implement the method of FIG. 6.

If programmable logic is used, such logic can execute on a commercially available processing platform configured by executable software code to become a specific purpose computer or a special purpose device (e.g., programmable logic array, application-specific integrated circuit, etc.). A person having ordinary skill in the art can appreciate that embodiments of the disclosed subject matter can be practiced with various computer system configurations, including multi-core multiprocessor systems, minicomputers, mainframe computers, computers linked or clustered with distributed functions, as well as pervasive or miniature computers that can be embedded into virtually any device. For instance, at least one processor device and a memory can be used to implement the above-described embodiments.

A processor unit or device as discussed herein can be a single processor, a plurality of processors, or combinations thereof. Processor devices can have one or more processor “cores.” The terms “computer program medium,” “non-transitory computer readable medium,” and “computer usable medium” as discussed herein are used to generally refer to tangible media such as a removable storage unit 818, a removable storage unit 822, and a hard disk installed in hard disk drive 812.

Various embodiments of the present disclosure are described in terms of this example computer system 800. After reading this description, it will become apparent to a person skilled in the relevant art how to implement the present disclosure using other computer systems and/or computer architectures. Although operations can be described as a sequential process, some of the operations can in fact be performed in parallel, concurrently, and/or in a distributed environment, and with program code stored locally or remotely for access by single or multi-processor machines. In addition, in some embodiments the order of operations can be rearranged without departing from the spirit of the disclosed subject matter.

Processor device 804 can be a special purpose or a general purpose processor device specifically configured to perform the functions discussed herein. The processor device 804 can be connected to a communications infrastructure 806, such as a bus, message queue, network, multi-core message-passing scheme, etc. The network can be any network suitable for performing the functions as disclosed herein and can include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 800 can also include a main memory 808 (e.g., random access memory, read-only memory, etc.), and can also include a secondary memory 810. The secondary memory 810 can include the hard disk drive 812 and a removable storage drive 814, such as a floppy disk drive, a magnetic tape drive, an optical disk drive, a flash memory, etc.

The removable storage drive 814 can read from and/or write to the removable storage unit 818 in a well-known manner. The removable storage unit 818 can include a removable storage media that can be read by and written to by the removable storage drive 814. For example, if the removable storage drive 814 is a floppy disk drive or universal serial bus port, the removable storage unit 818 can be a floppy disk or portable flash drive, respectively. In one embodiment, the removable storage unit 818 can be non-transitory computer readable recording media.

In some embodiments, the secondary memory 810 can include alternative means for allowing computer programs or other instructions to be loaded into the computer system 800, for example, the removable storage unit 822 and an interface 820. Examples of such means can include a program cartridge and cartridge interface (e.g., as found in video game systems), a removable memory chip (e.g., EEPROM, PROM, etc.) and associated socket, and other removable storage units 822 and interfaces 820 as will be apparent to persons having skill in the relevant art.

Data stored in the computer system 800 (e.g., in the main memory 808 and/or the secondary memory 810) can be stored on any type of suitable computer readable media, such as optical storage (e.g., a compact disc, digital versatile disc, Blu-ray disc, etc.) or magnetic tape storage (e.g., a hard disk drive). The data can be configured in any type of suitable database configuration, such as a relational database, a structured query language (SQL) database, a distributed database, an object database, etc. Suitable configurations and storage types will be apparent to persons having skill in the relevant art. For example, a main memory or secondary memory of the blockchain node 110 may include user account profile databases that store a plurality of user account profiles.

The computer system 800 can also include a communications interface 824. The communications interface 824 can be configured to allow software and data to be transferred between the computer system 800 and external devices. Exemplary communications interfaces 824 can include a modem, a network interface (e.g., an Ethernet card), a communications port, a PCMCIA slot and card, etc. Software and data transferred via the communications interface 824 can be in the form of signals, which can be electronic, electromagnetic, optical, or other signals as will be apparent to persons having skill in the relevant art. The signals can travel via a communications path 826, which can be configured to carry the signals and can be implemented using wire, cable, fiber optics, a phone line, a cellular phone link, a radio frequency link, etc.

The computer system 800 can further include a display interface 802. The display interface 802 can be configured to allow data to be transferred between the computer system 800 and external display 830. Exemplary display interfaces 802 can include high-definition multimedia interface (HDMI), digital visual interface (DVI), video graphics array (VGA), etc. The display 830 can be any suitable type of display for displaying data transmitted via the display interface 802 of the computer system 800, including a cathode ray tube (CRT) display, liquid crystal display (LCD), light-emitting diode (LED) display, capacitive touch display, thin-film transistor (TFT) display, etc.

Computer program medium and computer usable medium can refer to memories, such as the main memory 808 and secondary memory 810, which can be memory semiconductors (e.g., DRAMs, etc.). These computer program products can be means for providing software to the computer system 800. Computer programs (e.g., computer control logic) can be stored in the main memory 808 and/or the secondary memory 810. Computer programs can also be received via the communications interface 824. Such computer programs, when executed, can enable computer system 800 to implement the present methods as discussed herein. In particular, the computer programs, when executed, can enable processor device 804 to implement the methods illustrated by FIG. 7, as discussed herein. Accordingly, such computer programs can represent controllers of the computer system 800. Where the present disclosure is implemented using software, the software can be stored in a computer program product and loaded into the computer system 800 using the removable storage drive 814, interface 820, and hard disk drive 812, or communications interface 824.

The processor device 804 can comprise one or more modules or engines configured to perform the functions of the computer system 800. Each of the modules or engines can be implemented using hardware and, in some instances, can also utilize software, such as corresponding to program code and/or programs stored in the main memory 808 or secondary memory 810. In such instances, program code can be compiled by the processor device 804 (e.g., by a compiling module or engine) prior to execution by the hardware of the computer system 800. For example, the program code can be source code written in a programming language that is translated into a lower level language, such as assembly language or machine code, for execution by the processor device 804 and/or any additional hardware components of the computer system 800. The process of compiling can include the use of lexical analysis, preprocessing, parsing, semantic analysis, syntax-directed translation, code generation, code optimization, and any other techniques that can be suitable for translation of program code into a lower level language suitable for controlling the computer system 800 to perform the functions disclosed herein. It will be apparent to persons having skill in the relevant art that such processes result in the computer system 800 being a specially configured computer system 800 uniquely programmed to perform the functions discussed above.

Techniques consistent with the present disclosure provide, among other features, systems and methods for enabling blockchain based traceability of immutable transactions. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or can be acquired from practicing of the disclosure, without departing from the breadth or scope.

What is claimed is:

1. A method for creating traceability within a network system, the method comprising:
receiving, by a processing server, a first account request message, from a first computing system, wherein said account request message (i) requests creation of a first tagged blockchain account configured to store at least a first amount of tagged funds and (ii) includes an identifier associated with the first computing system and the first amount of tagged funds;
creating, by the processing server, the first tagged blockchain account on a blockchain stored on a blockchain network, said blockchain running in parallel with a payment gateway service maintained by the processing server;
receiving, by the processing server, a second account request message, from a second computing system, wherein said second account request message (i) requests creation of a second tagged blockchain account configured to receive tagged funds and (ii) includes an identifier associated with the second computing system;
creating, by the processing server, the second tagged blockchain account on the blockchain;
once the processing server creates the first and second tagged blockchain accounts, receiving, by the processing server, from the first computing system, a disbursement request that identifies (i) an account identifier associated with the first tagged blockchain account, (ii) an account identifier associated with the second tagged blockchain account, and (iii) a second amount of tagged funds;
transferring, by the processing server, the second amount of tagged funds from the first amount of tagged funds in the first tagged blockchain account to the second tagged blockchain account; and
concurrent with the transferring of the second amount of tagged funds, creating, by the processing server, a genesis block on the blockchain that includes a unique identifier tag assigned to the received disbursement request and disbursement details associated with the disbursement of the second amount of tagged funds.

2. The method of claim 1, further comprising:
receiving, by the processing server, from the blockchain network, first account information associated with the created first tagged blockchain including at least a first account identifier; and
receiving, by the processing server, from the blockchain network, second account information associated with the created second tagged blockchain account including at least a second account identifier.

3. The method of claim 2, further comprising:
receiving, by the processing server, from a third computing system, a transaction request message for a transaction, wherein the transaction request message includes a plurality of data fields, including at least (i) a first data field storing a payment account identifier, (ii) a second data field storing a payment amount, (iii) a third data field storing a specialized tag, and (iv) a fourth data field storing a recipient account identifier.

4. The method of claim 3, further comprising:
in response to detecting the specialized tag in the transaction request, executing a query, on the blockchain, and identifying the second tagged blockchain account based on the payment account identifier included in the transaction request message matching the second account identifier of the second tagged blockchain account; and
processing, by the processing server, the transaction between a recipient transaction account associated with the recipient account identifier and the second tagged blockchain account for the payment amount.

5. The method of claim 1, further comprising:
receiving, by the processing server, from a third computing system, a transaction request message for a transaction, wherein the transaction request message includes a plurality of data fields, including at least (i) a first data field storing a payment account identifier associated with the second tagged blockchain account, (ii) a second data field storing a payment amount, (iii) a third data field storing a specialized tag, and (iv) a fourth data field storing a recipient account identifier;
in response to detecting the specialized tag, identifying the genesis block stored on the blockchain based on the specialized tag in the transaction request message matching the unique identifier tag of the genesis block; and
creating, by the processing server, a second block in the blockchain, wherein the second block includes the unique identifier tag and transaction details associated with the transaction.

6. The method of claim 1, wherein the second computing system is an intermediate organization associated with at least one consumer, wherein the method further comprises:
transferring, by the processing server, a third amount of tagged funds from the second amount of tagged funds in the second tagged blockchain account to a blockchain wallet associated with the at least one consumer;
creating, by the processing server, a second block in the blockchain, wherein the second block includes the unique identifier tag and details associated with the transferring of the third amount of tagged funds.

7. The method of claim 6, further comprising:
issuing, by the processing server, a payment card associated with the blockchain wallet of the at least one consumer.

8. The method of claim 6, further comprising:
receiving, by the processing server, from a third computing system, a transaction request message for a transaction, wherein the transaction request message includes a plurality of data fields, including at least (i) a first data field storing a payment account identifier associated with the blockchain wallet of the at least one consumer, (ii) a second data field storing a payment amount, and (iii) a third data field storing a specialized tag;
in response to detecting the specialized tag, identifying the genesis block and second block stored on the blockchain based on the specialized tag in the transaction request message matching the unique identifier tag of the genesis block and second block; and
creating, by the processing server, a third block in the blockchain, wherein the second block includes the unique identifier tag and transaction details associated with the transaction.

9. The method of claim 1, further comprising:
issuing, by the processing server, a payment card associated with the second tagged blockchain account to at least one consumer.

10. A network system for creating traceability comprising:
a processing server;
a first computing system;
a second computing system; and
a blockchain network, wherein
the processing server includes a processor and a memory storing instructions thereon that when executed by the processor cause the processor to
receive a first account request message, from the first computing system, wherein said account request message (i) requests creation of a first blockchain account configured to store at least a first amount of tagged funds and (ii) includes an identifier associated with the first computing system and the first amount of tagged funds;
create the first tagged blockchain account on a blockchain running in parallel with a payment gateway service maintained by the processing server;
receive a second account request message, from the second computing system, wherein said second account request message (i) requests creation of a second tagged blockchain account configured to receive tagged funds and (ii) includes an identifier associated with the second computing system;
create the second tagged blockchain account on the blockchain;
receive, once the first and second tagged blockchain accounts are created, a disbursement request from the first computing system, wherein the disbursement request identifies (i) a second amount of tagged funds, (ii) an account identifier associated with the first tagged blockchain account, and (iii) an account identifier associated with the second tagged blockchain account;
transfer the second amount of tagged funds from the first amount of tagged funds in the first tagged blockchain account to the second tagged blockchain account; and
create, concurrent with the transferring of currency, a genesis block on the blockchain that includes (i) a unique identifier tag assigned to the disbursement request and (ii) disbursement details associated with the disbursement of the second amount of tagged funds.

11. The network system of claim 10, wherein the instructions, when executed by the processor, further cause the processor to
receive, from the blockchain network, first account information associated with the created first tagged blockchain including at least a first account identifier; and
receive, from the blockchain network, second account information associated with the created second tagged blockchain account including at least a second account identifier.

12. The network system of claim 11, wherein the instructions, when executed by the processor, further cause the processor to
receive, from a third computing system, a transaction request message for a transaction, wherein the transaction request message includes a plurality of data fields, including at least (i) a first data field storing a payment account identifier, (ii) a second data field storing a payment amount, (iii) a third data field storing a specialized tag, and (iv) a fourth data field storing a recipient account identifier.

13. The network system of claim 12, wherein the instructions, when executed by the processor, further cause the processor to
execute, in response to detecting the specialized tag in the transaction request, a query, on the blockchain, and identify the second tagged blockchain account based on the payment account identifier included in the transaction request message matching the second account identifier of the second tagged blockchain account; and
process the transaction between a recipient transaction account associated with the recipient account identifier and the second tagged blockchain account for the payment amount.

14. The network system of claim 10, wherein the instructions, when executed by the processor, further cause the processor to
receive, from a third computing system, a transaction request message for a transaction, wherein the transaction request message includes a plurality of data fields, including at least (i) a first data field storing a payment account identifier associated with the second tagged blockchain account, (ii) a second data field storing a payment amount, (iii) a third data field storing a specialized tag, and (iv) a fourth data field storing a recipient account identifier;
identify, in response to detecting the specialized tag, the genesis block stored on the blockchain based on the specialized tag in the transaction request message matching the unique identifier tag of the genesis block; and
create a second block in the blockchain, wherein the second block includes the unique identifier tag and transaction details associated with the transaction.

15. The network system of claim 10, wherein the second computing system is an intermediate organization associated with at least one consumer, and wherein the instructions, when executed by the processor, further cause the processor to
transfer a third amount of tagged funds from the second amount of tagged funds in the second tagged blockchain account to a blockchain wallet associated with the at least one consumer; and
create a second block in the blockchain, wherein the second block includes the unique identifier tag and details associated with the transferring of the third amount of tagged funds.

16. The network system of claim 15, wherein the instructions, when executed by the processor, further cause the processor to issue a payment card associated with the blockchain wallet of the at least one consumer.

17. The network system of claim 15, wherein the instructions, when executed by the processor, further cause the processor to
receive, from a third computing system, a transaction request message for a transaction, wherein the transaction request message includes a plurality of data fields, including at least (i) a first data field storing a payment account identifier associated with the blockchain wallet of the at least one consumer, (ii) a second data field storing a payment amount, and (iii) a third data field storing a specialized tag;
identify, in response to detecting the specialized tag, the genesis block and second block stored on the blockchain based on the specialized tag in the transaction request message matching the unique identifier tag of the genesis block and second block; and
create a third block in the blockchain, wherein the second block includes the unique identifier tag and transaction details associated with the transaction.

18. The network system of claim 10, wherein the instructions, when executed by the processor, further cause the processor to
issue a payment card associated with the second tagged blockchain account to at least one consumer.
